(19) United States
(12) Patent Application Publication
(10) Pub. No.: US 2011/0273447 A1
(43) Pub. Date: Nov. 10, 2011

(54) Connection-relation deciding program, computer aiding apparatus, computer aiding method

(75) Inventors: Hideki Abe, Kawasaki (JP); Masayoshi Hashima, Kawasaki (JP)

(73) Assignee: FUJITSU LIMITED, Kawasaki (JP)

(21) Appl. No.: 13/064,918

(22) Filed: Apr. 26, 2011

(30) Foreign Application Priority Data
May 10, 2010 (JP) 2010-108637

(51) Int. Cl. G06T 17/00

(52) U.S. Cl. 345/420

(57) ABSTRACT

A computer aiding apparatus includes a storage unit that stores therein pieces of component information on component basis; an calculating unit that searches from the storage unit for a piece of component information assigned to a bonding component that bonds components together and calculates an including shape includes the three-dimensional shape of the bonding component that is included in the piece of the component information found; a search unit that searches, in accordance with the arrangement position of the including shape calculated, for any piece of component information assigned to any component that interferes with the including shape from the storage unit; and a deciding unit that decides, depending on a function of the bonding component, an inter-component unmovable direction in which the component related to the piece of the component information that is found.

### CROSS-REFERENCE TO RELATED APPLICATION

This application is based upon and claims the benefit of priority of the prior Japanese Patent Application No. 2010-108637, filed on May 10, 2010, the entire contents of which are incorporated herein by reference.

### FIELD

The embodiments discussed herein are directed to a connection-relation deciding program, a computer aiding apparatus, and a computer aiding method.

### BACKGROUND

In mechanical component designing, it is important to verify components assembled in a three-dimensional (3D) model using a computer aided design (CAD). In 3D model verification, a function of automatically creating an exploded view of the 3D model and a function of analyzing tolerances of the components are used. The above functions need information about connection relation among the components.

A technology teaches a connection-relation-among-components calculating way that involves calculating the distances between polygons of components and calculating, using the shortest distance between components, a pair of components being in contact with each other. Another technology teaches a way that involves calculating the central axis of a cylindrical component body and the central axis of a hollow cylindrical component body and calculating, using the angle and the distance between the central axes that are calculated in a situation where these components are arranged at position indicated by the 3D model, a pair of components being bonded together.
Patent Document 1: Japanese Laid-open Patent Publication No. 2008-065708

However, the above conventional technology for calculating the connection relation between the bonded components has a problem in that as the number of components increases, the amount of calculation increases to an enormous amount. If the number of components increases, the number of polygons of the components increases and the number of combinations of the polygons increases. This increases the amount of calculation to an enormous amount. The above conventional technology for calculating a pair of bonded components using the angle and the distance between the central axes of the components has the same problem, i.e., as the number of the components increases, the number of combinations of the components increases and, therefore, the amount of calculation increases to an enormous amount.

### SUMMARY

According to an aspect of an embodiment of the invention, a computer-readable, non-transitory medium storing a connection-relation deciding program that causes a computer to execute a procedure, the procedure comprising: first searching, from a storage unit that stores therein pieces of component information on component basis, for a piece of component information assigned to a bonding component that bonds components together, components being objects that work as components and each piece of the component information including a three-dimensional shape of a corresponding component and a position where the component is arranged, and calculating an including shape so that the including shape includes the three-dimensional shape of the bonding component that is included in the piece of the component information found; second searching, in accordance with an arrangement position of the including shape calculated, for any piece of component information assigned to any component that interferes with the including shape from the storage unit; and deciding, depending on a function of the bonding component, an inter-component unmovable direction in which the component related to the piece of the component information found do not move. The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of the configuration of a computer aiding apparatus according to the first embodiment;

FIG. 2 is a schematic diagram that illustrates the concept of a connection-relation deciding process;

FIG. 3 is a functional block diagram of the configuration of a computer aiding apparatus according to the second embodiment;

FIG. 4 is a table that illustrates an example of the data structure of the component-information storage unit;

FIG. 5 is a table that illustrates an example of the data structure of the connection-information storage unit;

FIG. 6 is a schematic diagram of examples of including shape calculation;

FIG. 7 is a schematic diagram that illustrates an example of interfering component search;

FIG. 8 is a schematic diagram that illustrates an example of connection-relation calculation;

FIG. 9 is a flowchart of a connection-relation deciding process according to the second embodiment;

FIG. 10 is a flowchart of an interfering-component search process;

FIG. 11 is a flowchart of a connection-relation calculating process;

FIG. 12 is a schematic diagram that illustrates application of the connection-relation deciding process; and

FIG. 13 is a block diagram of a computer that executes a connection-relation deciding program.

### DESCRIPTION OF EMBODIMENTS

Preferred embodiments of the present invention will be explained with reference to accompanying drawings. It is noted that the present invention is not limited to the following embodiments.

### [a] First Embodiment

Configuration of a Computer Aiding Apparatus According to the First Embodiment

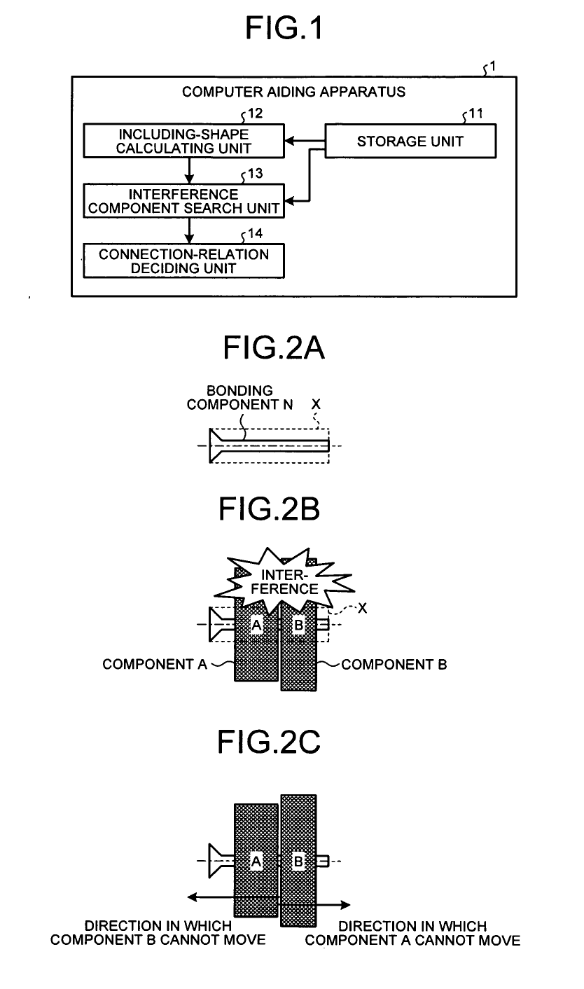

FIG. 1 is a functional block diagram of the configuration of a computer aiding apparatus according to the first embodiment. As illustrated in FIG. 1, a computer aiding apparatus 1 includes a storage unit 11, an including-shape calculating unit 12, an interference-component search unit 13, and a connection-relation deciding unit 14.

The storage unit 11 stores therein component information on a component basis, the component information including a 3D shape of an object that works as a component and a position where the component is arranged. The including-shape calculating unit 12 searches from the storage unit 11 for a piece of component information assigned to a bonding component that bonds components together and calculates an including shape so that the including shape includes the 3D shape of the bonding component that is included in the piece of the component information found. The bonding component is a component that bonds at least two components together and fixes them. The bonding component is, for example, a screw, a bolt, a snap-fit, a rivet, etc.

The interference-component search unit 13 searches, using an arrangement position of the including shape that is calculated by the including-shape calculating unit 12, for any piece of component information assigned to any component that interferes with the including shape from the storage unit 11. The connection-relation deciding unit 14 decides, depending on the function of the bonding component, an inter-component unmovable direction in which the component indicated by the piece of the component information found by the interference-component search unit 13 do not move. Although the function of the bonding component is the function for bonding components together, it also includes the shape of the bonding component.

The concept based on which a connection-relation deciding process is performed by the computer aiding apparatus 1 is described below with reference to FIG. 2. FIG. 2 is a schematic diagram that illustrates the concept of a connection-relation deciding process. As illustrated in FIG. 2A, the including-shape calculating unit 12 searches from the storage unit 11 for a piece of component information assigned to a bonding component N that bonds components together, and calculates an including shape X so that the including shape X includes the 3D-model shape of the bonding component N that is included in the piece of the component information found. In this example, the bonding component N is a screw.

As illustrated in FIG. 2B, the interference-component search unit 13 searches, in accordance with the arrangement position of the including shape X calculated by the including-shape calculating unit 12, for pieces of component information assigned to components A and B that interfere with the including shape X from the storage unit 11. In other words, the interference-component search unit 13 searches for the pieces of the component information assigned to the two components A and B that are arranged near the including shape X and interfere with the including shape X.

As illustrated in FIG. 2C, the connection-relation deciding unit 14 decides, depending on the function of the bonding component N, inter-component unmovable directions in which the components indicated by the pieces of the component information found by the interference-component search unit 13 do not move. For example, the function of the bonding component N indicates that the component A do not move in the direction toward the component B; the function of the bonding component N indicates that the component B may not move in the direction toward the component A. In other words, the component A that interferes with the bonding component N may not move toward the component B because the component B interferes with the bonding component N. On the other hand, the component B that interferes with the bonding component N may not move toward the component A because the component A interferes with the bonding component N.

As described above, the computer aiding apparatus 1 searches from the storage unit 11 for a piece of component information assigned to a bonding component that bonds components together, and calculates an including shape so that the including shape includes the 3D shape of the bonding component. With this configuration, the computer aiding apparatus 1 can search narrowed area around the including shape for any piece of component information assigned to any component that interferes with the including shape. This allows the computer aiding apparatus 1 to efficiently calculate, depending on the function of the bonding component, an inter-component unmovable direction in which the component that interferes with the including shape of the bonding component do not move.

### [b] Second Embodiment

Configuration of a Computer Aiding Apparatus According to the Second Embodiment

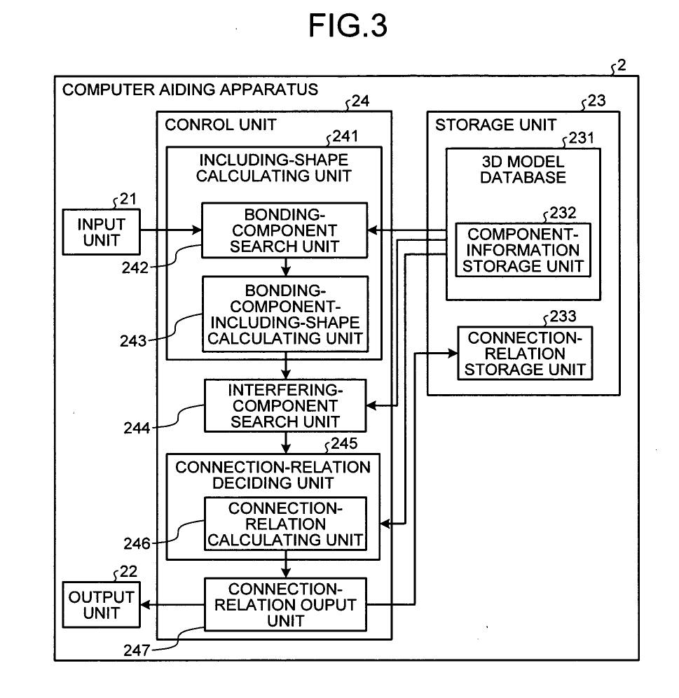

FIG. 3 is a functional block diagram of the configuration of a computer aiding apparatus 2 according to the second embodiment. The computer aiding apparatus 2 includes an input unit 21, an output unit 22, a storage unit 23, and a control unit 24.

The input unit 21 allows a user to input operation data and includes, for example, a keyboard, a mouse, or a touch-panel display, etc. The output unit 22 outputs, for example, the connection relation between bonded components that is decided by a later-described connection-relation deciding unit 245 and includes, for example, a cathode ray tube (CRT), a liquid crystal display (LCD), a touch-panel display, etc.

The storage unit 23 has a 3D model database 231 and a connection-relation storage unit 233. The storage unit 23 is, for example, a semiconductor memory, such as a random access memory (RAM) and a flash memory, or a storage device, such as a hard disk and an optical disk.

The 3D model database 231 is a database that contains 3D models of components, etc., and stores therein 3D data that contains components that are created using a computer aided design (CAD). The 3D data contains, for example, shape data indicative of 3D shapes of objects that work as components and position data indicative of positions where the components are arranged. The shape data indicative of 3D shapes can include polygon models of the components.

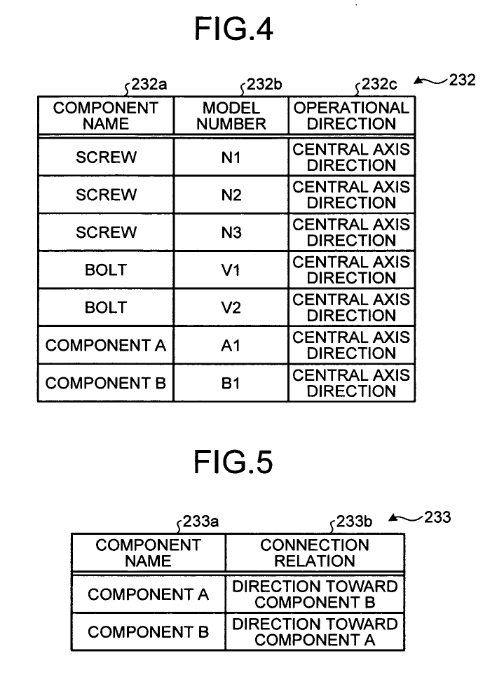

The 3D model database 231 includes a component-information storage unit 232. The component-information storage unit 232 stores therein a component-function-dependent operational direction of each component. The component-information storage unit 232 is described below with reference to FIG. 4. FIG. 4 is a table that illustrates an example of the data structure of the component-information storage unit. As illustrated in FIG. 4, the component-information storage unit 232 stores therein component name 232a, model number 232b, and operational direction 232c in associated with the model number 232b. The component name 232a is the name of a component. The component name 232a is, for example, screw, bolt, snap-fit or revert that is the name of a bonding component that bonds components together. The component name 232a is not only the name of a bonding component but also the name of a component that is bonded to another component with a bonding component.

The model number 232b is an identification number that is denoted depending on the function indicated by the component name 232a. If, for example, the component name 232a indicates that the bonding component can bond two components together, an identification number is assigned that indicates that the component can bond two components together. If, still for example, the component name 232a indicates that the bonding component can bond three components together, an identification number is assigned that indicates that the component can bond three components together.

The operational direction 232c indicates a direction in which the component indicated by the component name 232a operates. If, for example, the component name 232a indicates a bonding component, the corresponding operational direction 232c is the direction in which the bonding component operates to bond components, i.e., the central axis direction of the bonding component.

Referring back to FIG. 3, the connection-relation storage unit 233 stores therein an inter-component unmovable direction decided by the later-described connection-relation deciding unit 245 in associated with the component. The connection-relation storage unit 233 is described below with reference to FIG. 5. FIG. 5 is a table that illustrates an example of the data structure of the connection-information storage unit. As illustrated in FIG. 5, the connection-relation storage unit 233 stores therein connection relation 233b in associated with component name 233a.

The component name 233a is the name of a component that interferes with a bonding component. The connection relation 233b indicates the direction in which the component indicated by the component name 233a do not move. If, for example, the components A and B interfere with the same bonding component, the connection relation 233b assigned to the component A is the direction toward the component B. On the other hand, the connection relation 233b assigned to the component B is the direction toward the component A.

Referring back to FIG. 3, the control unit 24 includes an including-shape calculating unit 241, an interfering-component search unit 244, the connection-relation deciding unit 245, and a connection-relation output unit 247. The including-shape calculating unit 241 includes a bonding-component search unit 242 and a bonding-component-including-shape calculating unit 243. The connection-relation deciding unit 245 includes a connection-relation calculating unit 246. The control unit 24 is, for example, an integrated circuit, such as an application specific integrated circuit (ASIC) and a field programmable gate array (FPGA), or an electronic circuit, such as a central processing unit (CPU) and a micro processing unit (MPU).

The bonding-component search unit 242 searches from the 3D model database 231 by operation data that is received from the input unit 21 for a piece of component information assigned to a bonding component that bonds components together. More particularly, when the bonding-component search unit 242 receives the name of a specified bonding component from the input unit 21, it searches from the component-information storage unit 232 by the name of the bonding component for the corresponding model number 232b and the corresponding operational direction 232c as the component information. Moreover, the bonding-component search unit 242 searches from the 3D model database 231 by the name of the specified bonding component for the corresponding 3D shape and the corresponding arrangement position as the component information. Although, in the above, the bonding-component search unit 242 searches by the name of the specified bonding component received from the input unit 21 for the piece of the component information assigned to the bonding component, the bonding-component search unit 242 can be configured to search by the shape of the specified bonding component received from the input unit 21.

The bonding-component-including-shape calculating unit 243 calculates an including shape so that the including shape includes the 3D shape of the bonding component that is included in the piece of the component information found by the bonding-component search unit 242. The 3D-shape-including shape is, for example, a rectangular parallelepiped, i.e., a bounding box. The 3D-shape-including shape can be a circular cylinder.

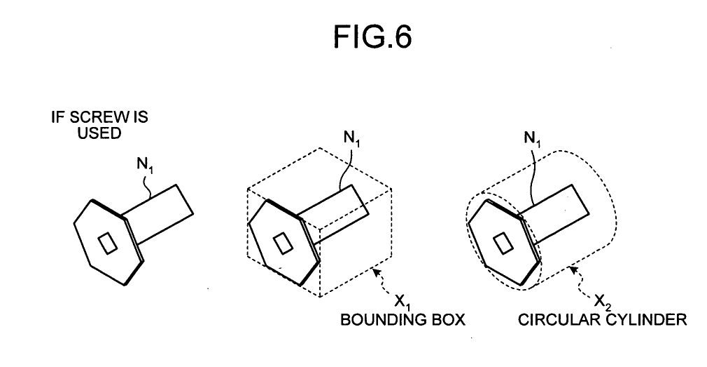

The including shape calculation is described below with reference to the examples illustrated in FIG. 6. FIG. 6 is a schematic diagram of examples of including shape calculation. As illustrated in FIG. 6, if the bonding component is a screw N₁, a shape that includes the 3D shape of the screw N₁ is, for example, a bounding box X₁. The shape that includes the 3D shape of the screw N₁ can be, for example, a circular cylinder X₂. The circular cylinder X₂ is large enough to include the top of the 3D shape of the screw N₁.

Referring back to FIG. 3, the interfering-component search unit 244 searches, in accordance with the arrangement position of the including shape calculated by the bonding-component-including-shape calculating unit 243, for any piece of component information assigned to any component that interferes with the including shape from the 3D model database 231. More particularly, the interfering-component search unit 244 separates the bonding component including shape that is calculated by the bonding-component-including-shape calculating unit 243 into a plurality of polygons. The interfering-component search unit 244 sequentially selects, from the pieces of the component information stored in the 3D model database 231, any piece of component information assigned to any component that is arranged within a certain range measured from the arrangement position of the specified bonding component. The interfering-component search unit 244 then separates the 3D shape that is the piece of the component information assigned to the selected component into a plurality of polygons. The certain range is a range of distance within which the bonding component can interfere with another component. The certain range can be an individual bonding-component-based value that is calculated in accordance with the dimension of the bonding component or the common value that is calculated in accordance with the dimension of the largest bonding component selected from all the types of the bonding components.

The interfering-component search unit 244 determines whether any polygon that is a section of the 3D shape included in the piece of the component information assigned to the selected component intersects with any polygon that is a section of the bonding component including shape. If the interfering-component search unit 244 determines that any polygon that is a section of the 3D shape included in the piece of the component information assigned to the selected component intersects with any polygon that is a section of the bonding component including shape, the interfering-component search unit 244 stores the piece of the component information and the position of the intersection in the 3D model database 231 as temporary data. In other words, the interfering-component search unit 244 determines that the selected component interferes with the bonding component.

If the interfering-component search unit 244 determines that any polygon that is a section of the 3D shape included in the component information assigned to the selected component does not intersect with any polygon that is a section of the bonding component including shape, the interfering-component search unit 244 selects the next component. In other words, the interfering-component search unit 244 determines that the selected component does not interfere with the bonding component. A method useful to search for any component that interferes with the bonding component including shape is, for example, a polygon interference check algorism.

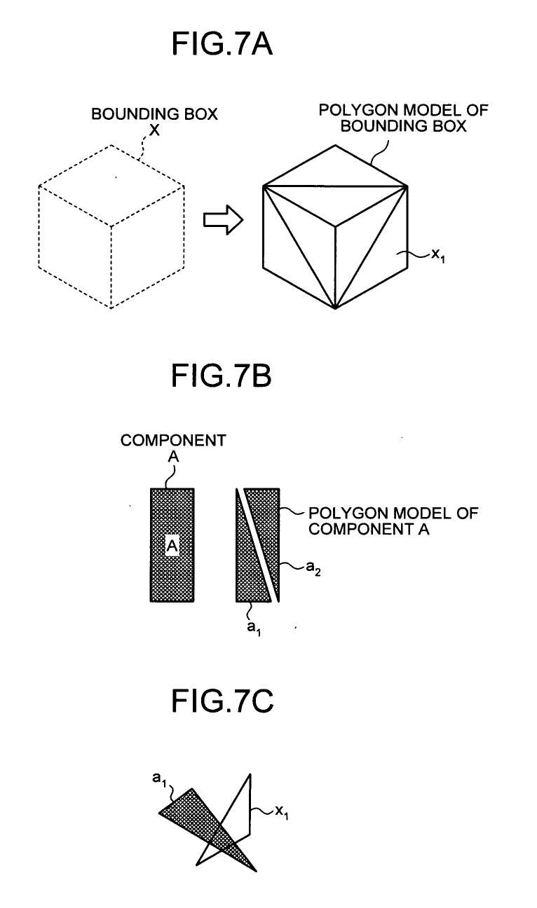

The interfering component search is described below with reference to the example illustrated in FIG. 7. FIG. 7 is a schematic diagram that illustrates an example of the interfering component search. As illustrated in FIG. 7A, the interfering-component search unit 244 determines the bonding component including shape to be a bounding box X and separates the bounding box X into a plurality of polygons. In this example, the bounding box X has a polygon x₁.

As illustrated in FIG. 7B, the interfering-component search unit 244 selects, from the pieces of the component information stored in the 3D model database 231, the piece of the component information assigned to the component A and separates the 3D shape that is included in the piece of the component information assigned to the selected component A into a plurality of polygons. In this example, the component A has 3D-shape polygons a₁ and a₂.

As illustrated in FIG. 7C, the interfering-component search unit 244 determines whether any polygon that is a section of the 3D shape included in the piece of the component information assigned to the selected component A intersects with any polygon that is a section of the bonding component including bounding box X. In this example, the polygon a₁ that is a section of the 3D shape of the selected component A intersects with the polygon x₁ that is a section of the bonding-component-including bounding box X; therefore, the interfering-component search unit 244 determines the component A to be a component that interferes with the bonding component.

Referring back to FIG. 3, the connection-relation calculating unit 246 decides, depending on the function of the bonding component, an inter-component unmovable direction in which the component indicated by the piece of the component information found by the interfering-component search unit 244 do not move. More particularly, the connection-relation calculating unit 246 reads, from the component-information storage unit 232, the operational direction 232c of the specified bonding component. Moreover, if two or more components that interfere with the bonding component are found by the interfering-component search unit 244, the connection-relation calculating unit 246 determines that the found two or more components are in contact with each other. The connection-relation calculating unit 246 then calculates, using the position of the intersection of the polygon of the bonding component and the polygon of each component that interferes with the bonding component, the layout of each component with respect to the operational direction 232c of the bonding component. The connection-relation calculating unit 246 then decides, in accordance with the layout of each component, a direction in which the component do not move. If, for example, the component A is on a side of the component B, the direction in which the component A do not move is the direction toward the component B and the direction in which the component B do not move is the direction toward the component A. If, for example, the component A is on a side of the component B and the component B is on a side of a component C, the direction in which the component A do not move is the direction toward the component B, the direction in which the component B do not move is the directions toward the components A and C, and the direction in which the component C do not move is the direction toward the component B.

If the interfering-component search unit 244 finds only one component that interferes with the bonding component, the connection-relation calculating unit 246 determines that the found component is not in contact with another component and decides that the found component can move in any direction.

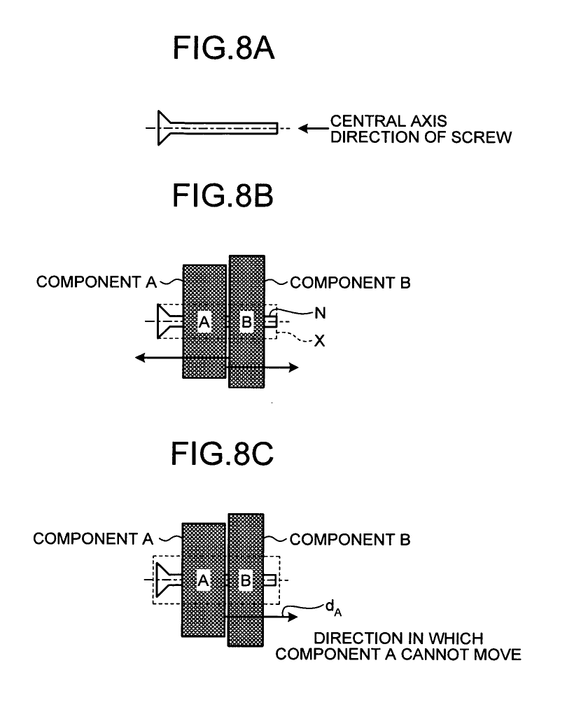

The connection-relation calculation is described below with reference to the example illustrated in FIG. 8. FIG. 8 is a schematic diagram that illustrates an example of the connection-relation calculation. As illustrated in FIG. 8A, the connection-relation calculating unit 246 reads, from the component-information storage unit 232, the operational direction 232c of the specified bonding component. In this example, the specified bonding component is a screw N, and the connection-relation calculating unit 246 reads the operational direction 232c “central axis direction” of the screw N from the component-information storage unit 232.

As illustrated in FIG. 8B, if the components A and B interfere with the screw N, the direction in which the components A and B do not move is the operational direction of the screw N, i.e., the “central axis direction”. If there are two or more components that interfere with the screw N, because these components are in contact with each other, each of the components A and B do not move in a certain direction with respect to the “central axis direction” of the screw N.

As illustrated in FIG. 8C, because the components A and B are found that interfere with the screw N, i.e., two or more components are found, the connection-relation calculating unit 246 determines that the components A and B are in contact with each other. The connection-relation calculating unit 246 then calculates, using both the position of the intersection of the polygon of the screw N and the polygon of the component A and the position of the intersection of the polygon of the screw N and the polygon of the component B, the layout of each of the components A and B with respect to the “central axis direction” of the screw N. In this example, with respect to the “central axis direction” of the screw N, the component A is in front of the component B. The connection-relation calculating unit 246 then decides that a direction along the “central axis direction” of the screw N and toward the component B to be an unmovable direction d_{A} in which the component A do not move. This direction information is assumed to be the connection relation assigned to the component A with respect to the component B. On the other hand, the connection-relation calculating unit 246 decides a direction along the “central axis direction” of the screw N and toward the component A to be an unmovable direction in which the component B do not move. The direction information is assumed to be the connection relation assigned to the component B with respect to the component A.

Referring back to FIG. 3, the connection-relation output unit 247 stores the unmovable direction of each component that is calculated by the connection-relation calculating unit 246 in the connection-relation storage unit 233. The components A and B are, for example, bonded together with a bonding component. The connection-relation output unit 247 then stores the direction in which the component A do not move, i.e., “the direction toward the component B” in the connection-relation storage unit 233 as the connection relation 233b assigned to the component A. On the other hand, the connection-relation output unit 247 stores the direction in which the component B do not move, i.e., “the direction toward the component A” in the connection-relation storage unit 233 as the connection relation 233b assigned to the component B. Although, in the above description, the connection-relation output unit 247 stores “the direction toward the component B” in the connection-relation storage unit 233 as the connection relation 233b, the configuration is not limited thereto. It is allowable to store a 3D vector value indicative of the direction along the operational direction of the bonding component and toward the component B.

Connection-Relation Deciding Process According to the Second Embodiment

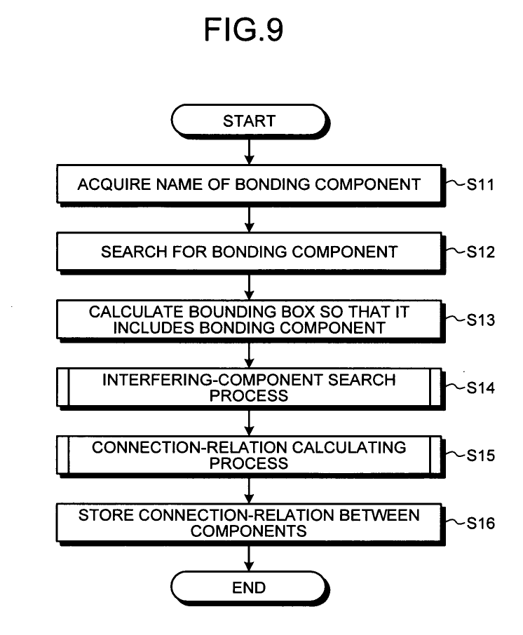

A connection-relation deciding process is described below with reference to FIG. 9 according to the second embodiment. FIG. 9 is a flowchart of a connection-relation deciding process according to the second embodiment.

First, the bonding-component search unit 242 acquires the name of the specified bonding component from the input unit 21 (Step S11). Then, the bonding-component search unit 242 searches from the 3D model database 231 for the piece of the component information assigned to the specified bonding component (Step S12). Although, in the above process, the bonding-component search unit 242 searches by the name of the specified bonding component for the piece of the component information assigned to the bonding component, it is allowable to search by the shape of the specified bonding component for the piece of the component information assigned to the bonding component.

Thereafter, the bonding-component-including-shape calculating unit 243 calculates a bounding box so that the bounding box includes the 3D shape of the bonding component that is included in the piece of the component information found by the bonding-component search unit 242 (Step S13). The bonding-component-including-shape calculating unit 243 can be configured to calculate, instead of a bounding box, a circular cylinder as the 3D shape including shape.

Thereafter, the interfering-component search unit 244 searches, in accordance with the arrangement position of the bounding box calculated by the bonding-component-including-shape calculating unit 243, for any piece of component information assigned to any component that interferes with the bounding box from the 3D model database 231 (Step S14). The connection-relation calculating unit 246 then decides, depending on the function of the specified bonding component, an inter-component unmovable direction in which the component indicated by the piece of the component information found by the interfering-component search unit 244 do not move (Step S15).

After that, the connection-relation output unit 247 stores the inter-component unmovable direction calculated by the connection-relation calculating unit 246 in the connection-relation storage unit 233 (Step S16). The inter-component unmovable direction can be expressed by using either the name of a certain component name or the 3D vector value indicative of the direction along the operational direction of the bonding component and toward a certain component.

Interfering-Component Search Process

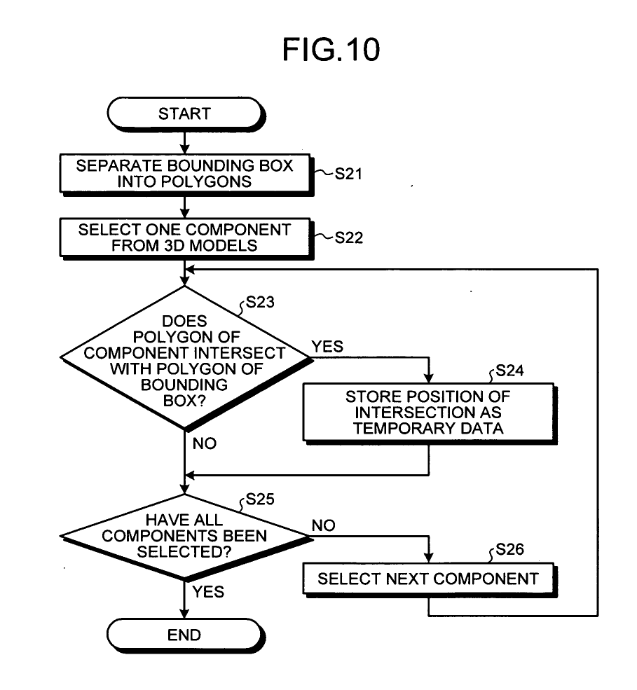

The interfering-component search process performed at Step S14 of FIG. 9 is described below with reference to FIG. 10. FIG. 10 is a flowchart of an interfering-component search process.

As illustrated in FIG. 10, first, the interfering-component search unit 244 separates the bonding component including bounding box that is calculated by the bonding-component-including-shape calculating unit 243 into a plurality of polygons (Step S21). The interfering-component search unit 244 then selects, from the 3D model database 231, a piece of component information assigned to one component that is arranged within the certain range measured from the arrangement position of the specified bonding component (Step S22) and separates the 3D shape that is included in the selected piece of the component information into a plurality of polygons. Although, in the above process, the interfering-component search unit 244 separates the 3D shape of the component into a plurality of polygons, the configuration is not limited thereto. If, for example, a polygon model of the component is included in the piece of the component information, it is allowable to acquire the polygon model.

Thereafter, the interfering-component search unit 244 determines whether any polygon that is a section of the 3D shape included in the piece of the component information assigned to the selected component intersects with any polygon that is a section of the bonding component including shape (Step S23). If any polygon that is a section of the 3D shape included in the piece of the component information intersects with any polygon that is a section of bonding component including shape (Yes at Step S23), the piece of the component information assigned to the selected component and the position of the intersection are stored as temporary data (Step S24). After that, the process control goes to Step S25 and the interfering-component search unit 244 performs the process of Step S25.

On the other hand, If any polygon that is a section of the 3D shape included in the piece of the component information assigned to the component selected by the interfering-component search unit 244 does not intersect with any polygon that is a section of bonding component including shape (No at Step S23), the process control goes to Step S25.

After that, the interfering-component search unit 244 determines whether all the components that are arranged within the certain range measured from the arrangement position of the specified bonding component have been selected from the 3D model database 231 (Step S25). If it is determined that the interfering-component search unit 244 has selected all the pieces of component information assigned to the target components (Yes at Step S25), the interfering-component search process goes to end. On the other hand, it is determined that the interfering-component search unit 244 has not selected all the pieces of component information assigned to the target components (No at Step S25), the interfering-component search unit 244 selects a piece of component information assigned to an unselected component (Step S26), and the process control goes to Step S23.

Connection-Relation Calculating Process

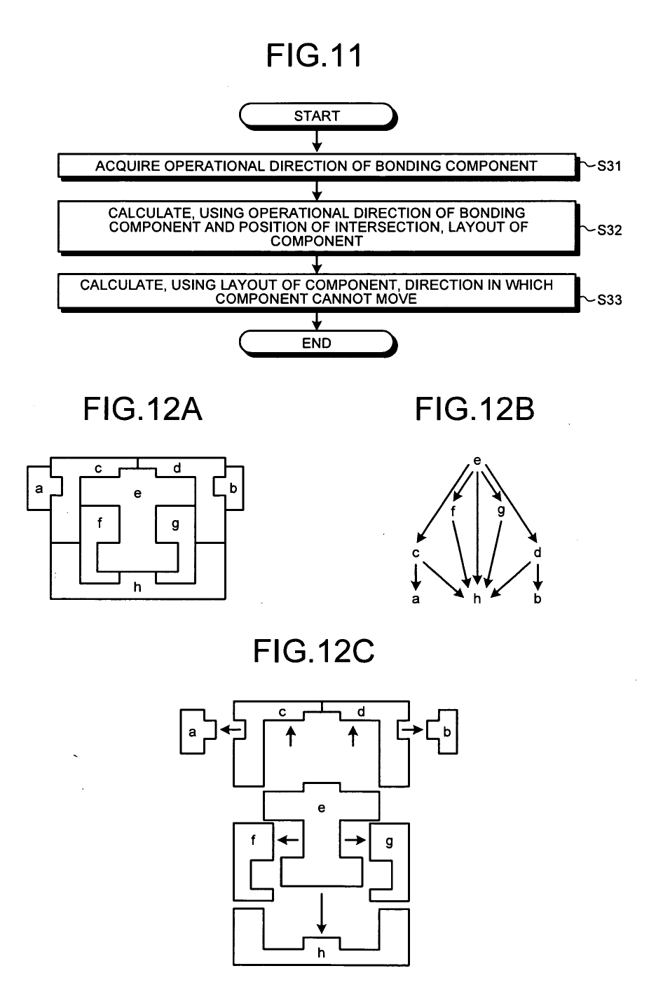

The connection-relation calculating process performed at Step S15 of FIG. 9 is described with reference to FIG. 11. FIG. 11 is a flowchart of a connection-relation calculating process. As illustrated in FIG. 11, first, the connection-relation calculating unit 246 acquires the operational direction of the specified bonding component from the component-information storage unit 232 (Step S31).

Then, the connection-relation calculating unit 246 calculates, using the position of the intersection of the polygon of the specified bonding component and the polygon of each component that interferes with the bonding component, the layout of each component with respect to the operational direction of the bonding component (Step S32). After that, the connection-relation calculating unit 246 calculates, using the layout of each component, an unmovable direction of each component (Step S33). If the interfering-component search unit 244 does not find two or more component interfering with the bonding component, the connection-relation calculating unit 246 determines that the found interfering component is not in contact with another component and decides that the found interfering component can move in any direction.

Effects of the Second Embodiment

The interfering-component search unit 244, in the above second embodiment, sequentially selects, from the pieces of the component information assigned to the components stored in the 3D model database 231, any piece of the component information assigned to any component that is arranged within the certain range measured from the arrangement position of the bonding component. The interfering-component search unit 244 then determines whether any polygon that is a section of the 3D shape included in the piece of component information assigned to the selected component intersects with any polygon that is a section of the bonding component including shape. With this configuration, because it is determined whether any polygon that is related to the component arranged within the certain range measured from the arrangement position of the bonding component intersects with any polygon that is related to the bonding component, the components that interfere with the bonding component are found quickly. In other words, because the interfering-component search unit 244 narrows search targets to the components that are arranged near the bonding component, the amount of calculation during the determining process decreases, which makes it possible to efficiently calculate the components interfering with the bonding component.

Moreover, in the second embodiment, the connection-relation output unit 247 stores the inter-component unmovable direction calculated by the connection-relation calculating unit 246 in associated with the corresponding component. With this configuration, because the inter-component unmovable direction is stored in associated with the corresponding component, the connection relation between the components is easily acquired. This is useful in a simulation analysis for CAD-based mechanical component designing.

Furthermore, in the second embodiment, the inter-component unmovable direction decided by the connection-relation deciding unit is the operational direction that is determined depending on the function of the bonding component. With this configuration, because the inter-component unmovable direction is the operational direction that is determined depending on the function of the bonding component, the connection relation between the components is easily calculated.

Application of the Connection-Relation Deciding Process

Application of the connection-relation deciding process is described below with reference to FIG. 12. FIG. 12 is a schematic diagram that illustrates application of the connection-relation deciding process. The reference symbols a to h in FIGS. 12A to 12C are components. As illustrated in FIG. 12, models that illustrate the connection relation among the components a to h used for the mechanical component designing, etc., includes an input model FIG. 12A that illustrates the component assembly, an exploded graph FIG. 12B expressed using a diagraph, and an exploded model FIG. 12C. The connection relation among the components is useful to automatically create an exploded view of the 3D model and analyze tolerances of the components. If the connection relation among the bonded components that is a result of the connection-relation deciding process according to the second embodiment is used, the models FIG. 12A, FIG. 12B, and FIG. 12C that illustrate the connection relation among the components are created quickly. This enables high-speed 3D-model-exploded-view automatically creating function and high-sped tolerance analysis function.

Program, Etc.

The computer aiding apparatuses 1 and 2 can be implemented by adding the functions of the input unit 21, the output unit 22, the storage unit 23, and the control unit 24 to an information processing apparatus, such as a well-known personal computer and a workstation.

The constituent elements of the device illustrated in the drawings are merely conceptual, and need not be physically configured as illustrated. The constituent elements, as a whole or in part, can be separated or integrated either functionally or physically based on various types of loads or use conditions. For example, the bonding-component search unit 242 and the bonding-component-including-shape calculating unit 243 can be integrated together into one unit. The interfering-component search unit 244 can be separated into an including shape polygon separating unit that separates the including shape related to the bonding component into polygons, a 3D-shape polygon separating unit that separates the 3D shape related to the selected component into polygon, and an intersection determining unit that determines whether any polygon of the including shape intersects with any polygon of the component shape. Moreover, the storage unit 23 can be an external device that is connected to the computer aiding apparatus 2 via a network. Especially, the 3D model database is preferably an external device that is connected to the computer aiding apparatus 2 via a network. Furthermore, the input unit 21 and the output unit 22 can be included in different devices connected via a network so that the input unit 21 and the output unit 22 operate together and implement the functions of the above computer aiding apparatus 2.

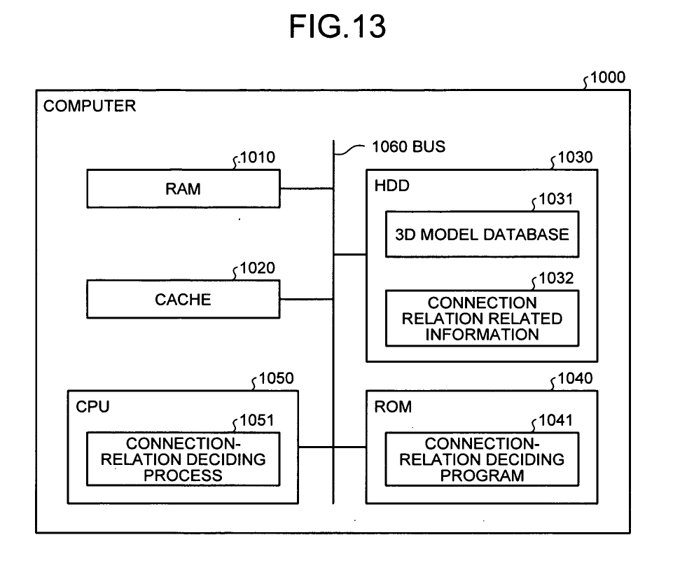

The processes described in the above embodiments can be performed when a computer, such as a personal computer and a workstation, executes prepared programs. An example of such a computer is described below with reference to FIG. 13 that executes a connection-relation deciding program to implement the same functions as those of the computer aiding apparatus 2 as illustrated in FIG. 3.

FIG. 13 is a block diagram of a computer that executes a connection-relation deciding program. As illustrated in FIG. 13, a computer 1000 includes a random access memory (RAM) 1010, a cache 1020, an HDD 1030, a read only memory (ROM) 1040, a central processing unit (CPU) 1050, and a bus 1060. The RAM 1010, the cache 1020, the HDD 1030, the ROM 1040, and the CPU 1050 are connected to each other via the bus 1060.

The ROM 1040 stores therein a connection-relation deciding program 1041 that is used to implement the same functions as those of the computer aiding apparatus 2 illustrated in FIG. 3.

The CPU 1050 then reads and executes the connection-relation deciding program 1041. At this time, as illustrated in FIG. 13, the connection-relation deciding program 1041 is turned to be a connection-relation deciding process 1051. The connection-relation deciding process 1051 corresponds to the control unit 24 illustrated in FIG. 3.

The HDD 1030 has, as illustrated in FIG. 13, a 3D model database 1031 and connection relation related information 1032. The 3D model database 1031 corresponds to for example, the 3D model database 231 included in the storage unit 23 illustrated in FIG. 3; the connection relation related information 1032 corresponds to the connection-relation storage unit 233 stored in the storage unit 23 illustrated in FIG. 3.

The above program 1041 does not need to be present in the ROM 1040 by default. For example, the program 1041 can be stored in a “portable physical medium” insertable to the computer 1000, such as a flexible disk (FD), a CD-ROM, an MO disk, a DVD disk, a magnetic optical disk. Alternatively, the program 1041 can be stored in a “stationary physical medium” such as an internal or external hard disk drive (HDD) of the computer 1000. Alternatively, the program 1041 can be stored in “another computer (or server)” that is connected to the computer 1000 via the public line, the Internet, a LAN, a WAN, or the like. The computer 1000 reads the programs from the flexible disk or the similar and executes the programs.

According to an embodiment of a connection-relation deciding program disclosed in the present application, a connection relation between bonded components is calculated efficiently.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it may be understood that the various changes, substitutions, and alterations could be made hereto without departing from the spirit and scope of the invention.

What is claimed is:

1. A computer-readable, non-transitory medium storing a connection-relation deciding program that causes a computer to execute a procedure, the procedure comprising:
first searching, from a storage unit that stores therein pieces of component information on component basis, for a piece of component information assigned to a bonding component that bonds components together, components being objects that work as components and each piece of the component information including a three-dimensional shape of a corresponding component and a position where the component is arranged, and
calculating an including shape so that the including shape includes the three-dimensional shape of the bonding component that is included in the piece of the component information found;
second searching, in accordance with an arrangement position of the including shape calculated, for any piece of component information assigned to any component that interferes with the including shape from the storage unit; and
deciding, depending on a function of the bonding component, an inter-component unmovable direction in which the component related to the piece of the component information found do not move.

2. The non-transitory computer readable storage medium according to claim 1, wherein the second searching includes
sequentially selecting, from the pieces of the component information stored in the storage unit, any piece of component information assigned to any component that is arranged within a certain range measured from the arrangement position of the bonding component, and
determining whether any polygon that is a section of a three-dimensional shape included in the selected piece of the component information assigned to the component intersects with any polygon that is a section of the including shape of the bonding component.

3. The computer-readable, non-transitory medium according to claim 1, the procedure further comprising:
storing the inter-component unmovable direction that is decided by the connection-relation deciding in associated with the component.

4. The non-transitory computer readable storage medium according to claim 3, wherein the inter-component unmovable direction is an operational direction that is determined depending on the function of the bonding component.

5. An apparatus comprising:
a storage unit that stores therein pieces of component information on component basis, and
a including-shape calculating unit that includes
searching, from the storage unit, for a piece of component information assigned to a bonding component that bonds components together, components being objects that work as components and each piece of the component information including a three-dimensional shape of a corresponding component and a position where the component is arranged, and
calculating an including shape so that the including shape includes the three-dimensional shape of the bonding component that is included in the piece of the component information found;
a interfering-component search unit that includes searching, in accordance with an arrangement position of the including shape that is calculated by the including shape calculating, for any piece of component information assigned to any component that interferes with the including shape from the storage unit; and
a connection-relation deciding unit that includes deciding, depending on a function of the bonding component, an inter-component unmovable direction in which the component related to the piece of the component information that is found by the interfering-component search do not move.

6. An apparatus comprising:
a storage unit that stores therein pieces of component information on component basis, and
a processor configured to execute a procedure, the procedure comprising:
searching, from the storage unit, for a piece of component information assigned to a bonding component that bonds components together, components being objects that work as components and each piece of the component information including a three-dimensional shape of a corresponding component and a position where the component is arranged, and
calculating an including shape so that the including shape includes the three-dimensional shape of the bonding component that is included in the piece of the component information found;
searching, in accordance with an arrangement position of the including shape calculated, for any piece of component information assigned to any component that interferes with the including shape from the storage unit; and
deciding, depending on a function of the bonding component, an inter-component unmovable direction in which the component related to the piece of the component information that is found by the interfering-component search do not move.

7. A method for aiding a computer in designing analysis using three-dimensional data, the method comprising:
searching, from a storage unit that stores therein pieces of component information on component basis, for a piece of component information assigned to a bonding component that bonds components together, components being objects that work as components and each piece of the component information including a three-dimensional shape of a corresponding component and a position where the component is arranged, and
calculating an including shape so that the including shape includes the three-dimensional shape of the bonding component that is included in the piece of the component information found;
searching, in accordance with an arrangement position of the including shape calculated, for any piece of component information assigned to any component that interferes with the including shape from the storage unit; and
deciding, depending on a function of the bonding component, an inter-component unmovable direction in which the component related to the piece of the component information that is found by the interfering-component search do not move.
